(19) United States
(12) Patent Application Publication
(10) Pub. No.: US 2003/0006047 A1
(43) Pub. Date: Jan. 9, 2003

(54) System and method for treating fires

(76) Inventors: Leonard A. Silverstein, Atlanta, GA (US); Jurgen Baumgart, Huntington Beach, CA (US)

Correspondence Address: VOLENTINE FRANCOS, P.L.L.C., Suite 150, 12200 Sunrise Valley Drive, Reston, VA, 20191, US

(21) Appl. No.: 10/163,355

(22) Filed: Jun. 7, 2002

Related U.S. Application Data
(60) Provisional application No. 60/300,069, filed on Jun. 25, 2001.

(51) Int. Cl. A62C 8/00

(52) U.S. Cl. 169/47; 169/36; 169/54; 169/46; 124/4; 124/81; 124/6; 124/82

(57) ABSTRACT

Fires in tanks storing combustible liquids are treated by introducing a fire extinguishing media comprising frozen projectiles onto the surface of the burning liquid. The media is applied across the surface of the burning fluid to extinguish the fire and prevent its re-ignition.

### CROSS REFERENCES TO RELATED APPLICATIONS

This application claims the priority benefit under 35 U.S.C. §119(e) from U.S. provisional patent application No. 60/300,069, filed on Jun. 25, 2001 naming inventor Leonard A. Silverstein, the entire contents of which are hereby incorporated herein by reference for all purposes as if fully set forth herein. This application is also related to copending U.S. patent application Ser. No. ______ [attorney docket no. PTS.001], filed concurrently herewith in the name of inventors Leonard A. Silverstein and Jurgen Baumgart, and entitled “Thrower System.”

### BACKGROUND AND SUMMARY OF THE INVENTION

1. Field of the Invention

This invention relates to systems and techniques for treating and extinguishing fires, particularly fires of flammable liquids stored in tanks. More particularly, this invention relates to the extinguishment of fires aboard tankers and in large, above ground, storage tanks for crude oil, refined products and other flammable liquids by providing methods and means for the creation and placement of a fire extinguishing substance at the surface of the burning liquid.

2. Description of the Related Art

The state of the art of foam extinguishing system for large tank and bund fires is well summarized in a report prepared by Henry Persson entitled, “Design, Equipment and Choice of Tactics are Critical When Fighting Large Tank and Bund Fires.” That report is further identified at Brandforsk Project: 612-902; Swedish National Testing and Research Institute, Fire Engineering, SP Report 1992:02.

A traditional approach to the fighting of such fires has been to direct streams of water and foam onto the fire site through monitors or even hand-held nozzles. In order to successfully extinguish large fires using traditional techniques, it is necessary to have available an adequate supply of water and foam concentrate to allow the application of foam liquid at a minimum rate of 6.5 l/min. to the burning surface for some 60 to 90 minutes. The report indicates agreement among the experts that concentrating foam application on as small an area in the tank as possible is far superior to the previously accepted technique of fighting tank fires with several small monitors distributed around the circumference of the tank. Concentrating the foam application at one point more quickly establishes a bridge head, or initial foam cover, thus increasing the effectiveness of subsequently applied foam.

A fixed, over-top system comprises permanently installed piping and foam sprinkler nozzles within the tank itself at a level above the liquid surface when the tank is filled to capacity. A bottom feed system employs a hose array with foam deploying nozzles adapted to float on the surface of the stored liquid and to rise and fall with the liquid as the tank is filled and emptied. Both systems require connection to water source and to a supply of foam concentrate. That connection may be a permanent one through direct attachment to the water and to a store of foam but the systems are more commonly supplied from a mobile unit which is connected to a system through hoses at the time of need. Both systems are difficult to maintain and are essentially impossible to test without contamination of the tank contents.

Fires aboard tankers carrying either crude oil or refined petroleum products pose many of the same problems as do fires in stationary tanks. Consequently, tanker fires have been traditionally fought using much the same tactics used in the fighting of stationary tank fires. However, the difficulties of access and of the coordination of equipment, personnel, and decision-making are ordinarily vastly greater in a tanker fire that those encountered at land locations.

Fires in tanker and stationary storage tanks, while relatively uncommon, pose enormous risks. Those risks include the threat of injury or death to people aboard the ship or in the area or engaged in fighting the fire, the likelihood of high property losses, and the nearly certain contamination of soils, beaches, ground and surface water and air. Further, the intense thermal radiation always threatens to ignite adjacent structures and tanks, thus compounding the risks and increasing the potential losses.

With this background, it can readily be appreciated that fire fighting tactics and systems which can more quickly and surely bring under control and extinguish fires aboard tankers and in tanks, particularly those fires in large stationery or mobile tanks, is of great environmental and economic importance.

Accordingly, it would be advantageous to provide a method for extinguishing fires that is less polluting and requires lower maintenance. It would be further advantageous to an apparatus for extinguishing fires that requires less maintenance and is easier to test.

### SUMMARY OF THE INVENTION

The present invention comprises an apparatus and method for applying a unique fire extinguishing substance to the surface of a burning liquid contained in a tank to thereby control and extinguish the fire and prevent its re-ignition and burnback.

In one aspect, the invention provides improved methods for fighting and extinguishing fires in petroleum tankers and storage facilities.

In another aspect, the invention provides an improved means and apparatus for applying the fire extinguishing substance to the surface of a burning liquid contained in a storage tank.

In another aspect, the invention provides improved methods and techniques for extinguishing fires and flammable liquids contained in storage tanks.

Still another object is to provide a fire extinguishing system that entails minimum clean-up after the fire is out and in which the fire extinguishing substance leaves no environmentally harmful residue.

Other objects will be apparent from the following description of exemplary embodiments and techniques.

### DESCRIPTION OF THE DRAWINGS

FIG. 1 is a schematic drawing of a system including a fire extinguishing projectile storage container, conveyor, thrower, stream of projectiles, and a representation of a burning hydrocarbon liquid in a tank and sinking fire extinguishing projectiles; and

FIG. 2 is a schematic drawing of a system including fire extinguishing projectile storage container, conveyor, thrower, stream of projectiles, and a representation of a burning hydrocarbon liquid in a tank and floating fire extinguishing projectiles.

### DESCRIPTION OF THE PREFERRED EMBODIMENTS

Various embodiments of this invention will be described and discussed in detail with references to the drawing figures. Embodiments and other aspects of the invention described herein, including the methods described below, may be made or used in conjunction with inventions described, in whole or in part, in co-pending U.S. patent application Ser. No. ______ [attorney docket no. PTS.001], filed concurrently herewith in the name of inventors Leonard A. Silverstein and Jurgen Baumgart, and entitled “Thrower System,” the entirety of which is incorporated by reference for all purposes as if fully set forth herein.

As used herein, the term “projectile” encompasses solid and hollow objects of various shapes, including pellets in the shape of cylinders, spheres, cubes, oblongs, or other shapes. For the treatment of fire, such projectiles beneficially comprise a cryogenic material, solid or hollow CO₂ (“dry ice”). Such cryogenic projectiles may be extruded, formed of compressed snow, or formed of frozen liquid or gases. Moreover, the materials may include significant amounts of other compounds or materials, particularly light, inert solid materials such as Perlite. Also, the projectiles may include a light core, either encapsulated or through use of a binder. Such projectiles may be of various sizes as desired, beneficially ranging from the size of rice grains up to a diameter of 5 inches, preferably having a diameter of from 0.75 inches to 2 inches in diameter.

As used herein, the term “frozen projectiles” includes projectiles made entirely or nearly entirely of a cryogenic material. In particular, beneficially the frozen projectiles include frozen or extruded carbon dioxide or compressed carbon dioxide snow, and also projectiles that include carbon dioxide together with significant amounts of other compounds or materials. Advantageously, cryogenic carbon dioxide sublimes into a gas without leaving a polluting reside that requires extensive clean-up. Particularly, the frozen projectiles may include a light, inert solid material. Beneficially, such a light inert solid material may be Perlite. Beneficially, the frozen projectiles have a spherical or near spherical shape for ease of handling and propulsion by the thrower as described below.

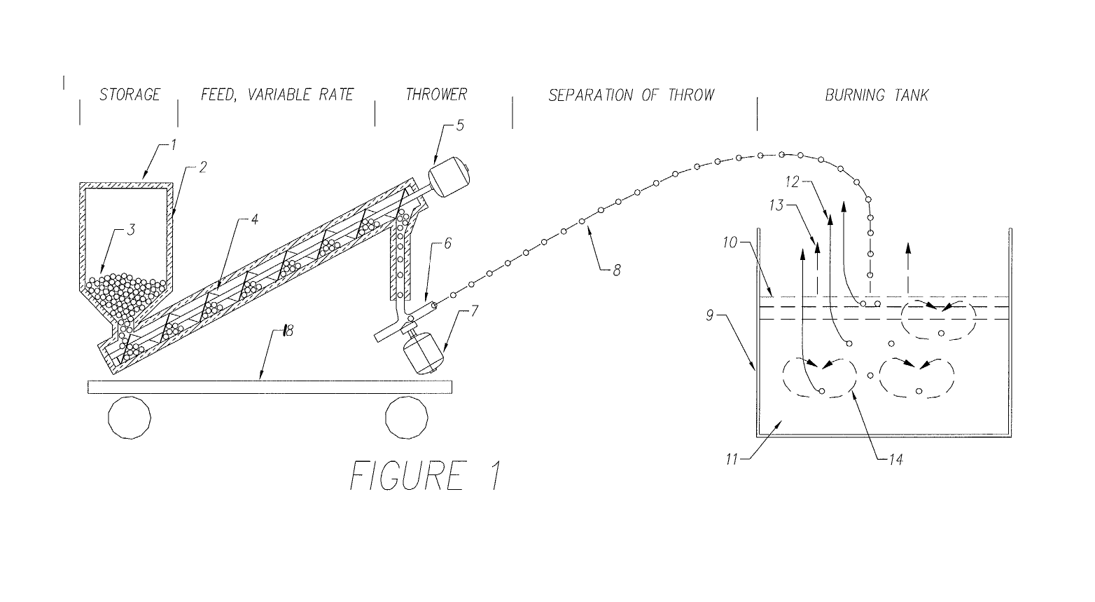

FIG. 1 depicts a thrower system [100]. The thrower system [100] includes a removable, refillable, transportable container [1] mounted to a transport platform [18]. The container [1] is filled with frozen projectiles, for example, frozen carbon dioxide projectiles [3]. Thermal insulation [2] incorporated with the container [1] allows for prolonged storage of the frozen carbon dioxide projectiles [3].

To extinguish a fire, such as a hydrocarbon fluid fire, the thrower system [100] throws a stream of the frozen carbon dioxide projectiles [3] onto the fire from a remote distance, as will be explained in more detail below.

To apply the frozen carbon dioxide projectiles [3] to a fire, the frozen projectiles [3] are transported by a conveyor [4] driven by a variable speed motor [5] to the feed tube of a rotating throw mechanism [6]. The rotating throw mechanism [6] is driven by a variable speed motor [7]. Beneficially, the throw angle of the throw mechanism [6] is adjustable in both horizontal and vertical planes. The distance of the throw is determined both by the speed and by vertical throw angle of the throw mechanism [6].

FIG. 1 illustrates how, by proper adjustment of the rotating throw mechanism [6], a stream of the frozen carbon dioxide projectiles [8] is directed to a tank [9] holding a burning liquid [11], where the frozen carbon dioxide projectiles [8] land on the burning surface [10]. As the frozen carbon dioxide projectiles [8] sink in the tank [9], they cool the liquid [11] and sublime to a carbon dioxide gas [12] having a volume of up to nine times larger than the frozen carbon dioxide projectiles [8]. This carbon dioxide gas [12] rises to the surface [10] and provides an inert dilution of any fuel vapors [13] feeding the fire. As the large volume of carbon dioxide gas [12] rises to the surface, it agitates the bulk liquid, (as shown by reference numeral [14] in the tank [9], causing the colder bulk liquid [11] to mix with the hotter liquid at the surface [10].

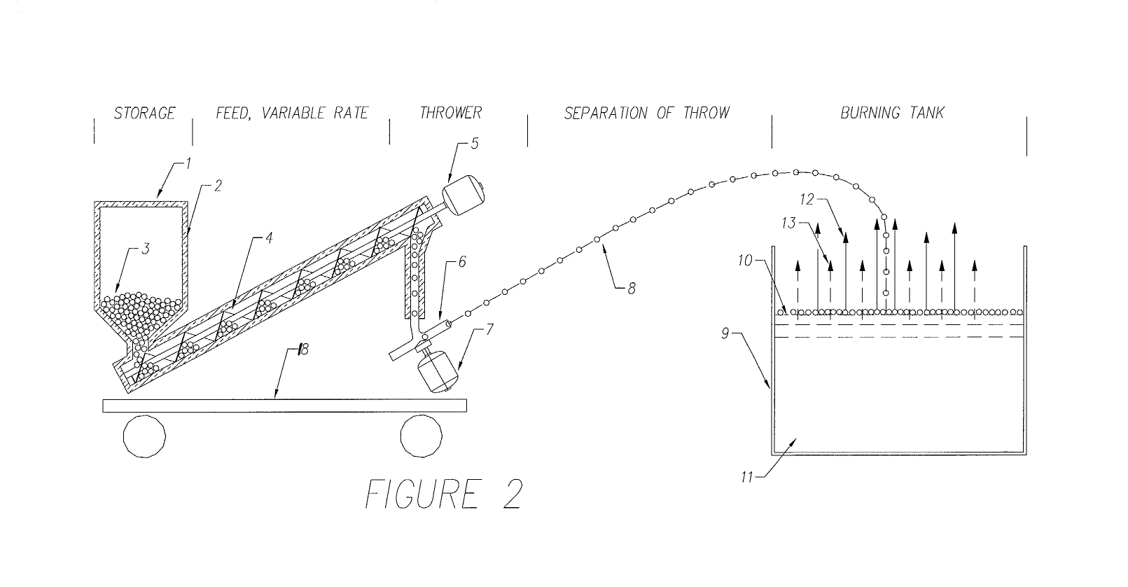

In contrast to the example of FIG. 1, in FIG. 2 the frozen carbon dioxide projectiles [8] land on the burning surface [10] and float. As the floating frozen carbon dioxide projectiles [8] sublime, they cool the liquid surface [10]. This inert carbon dioxide gas [12] rises and provides an inert dilution of any fuel vapors [13] evaporating at the surface. Additionally, the floating frozen carbon dioxide projectiles [8] provide a radiation barrier between the flames and the surface [10] of the liquid [11]. The bulk tank liquid [11] is only agitated by thermal circulation as the surface liquid cools below the bulk liquid temperature.

The example of FIG. 1, using the sinking projectiles, presents the following benefits: (a) as the projectiles sink into the burning liquid, they sublime into an inert gas many times the original volume, producing gas bubbles that agitate the liquid and cause the colder bulk liquid in the container to rise to the surface, in turn reducing the surface evaporation of fuel that feeds the fire; (b) the inert gas leaves at the surface and mixes with the evaporated fuel and the ambient gases to reduce the amount of oxygen available for combustion, moving the flame away from the liquid surface. As the flame distance to the liquid increases, heat input from the flame into the liquid and fuel evaporated from the surface are reduced.

The example of FIG. 2, using the floating projectiles, presents the following benefits: (a) the sublimation of the frozen carbon dioxide projectiles [8] cools the liquid surface and reduces evaporation of the liquid, and with it the fuel supply to the fire; (b) the floating carbon dioxide projectiles [8] form an insulating cover on the liquid surface, reducing heat input from the fire into the liquid and thus reducing the evaporation of the liquid that fuels the fire; (c) the inert gas at the surface mixes with the evaporated fuel and the ambient gases to reduce the amount of oxygen available for combustion, moving the flame away from the liquid surface. As the flame distance to the liquid increases, heat input from the flame into the liquid and fuel evaporated from the surface are reduced.

Moreover, where the floating frozen carbon dioxide projectiles [8] include an inert material (e.g., Perlite), as the carbon dioxide sublimes the Perlite floats on the surface of the liquid, forming an insulating blanket or barrier that reduces the rate of evaporation of the liquid.

In both examples above, the fire is extinguished by the stream of frozen carbon dioxide projectiles [8] through the combined effect of cooling the surface layer of the burning liquid, and providing inert diluting to any fuel vapor that is generated. The floating frozen carbon dioxide projectiles [8] also provide the liquid surface with shielding against radiated heat from the flame.

The fire itself feeds upon gases vaporized from the liquid. The rate of vaporization, in turn, depends upon the temperature of the surface liquid and upon the thermal radiation striking that surface. As shown in FIG. 1, as the column of carbon dioxide gas bubbles [12] rises within the liquid [11], it creates a circulating flow [14] of liquid from the lower portions of tank [9] toward the surface [10] thereof. The liquid [11] contained in the lower portion of the tank [9] is, at least in the early stages of a fire, considerably cooler than is the surface liquid. Circulation of the cooler bottom liquid thus decreases the vaporization rate and effectively decreases the amount of fuel fed to the fire. Moreover, penetration of the frozen carbon dioxide projectiles to the bottom of a storage tank and the circulation of the cooler bottom liquid also may break up the surface layer of petroleum tar that builds up in a crude oil tank fire that eventually may lead to a boil-over or slop-over.

The use of floating carbon dioxide projectiles, as shown by FIG. 2, cools the liquid surface more directly. In this case the effect of cooling also decreases the amount of fuel fed to the fire while avoiding the possible foaming and consequent spill-over characteristic shown by some hydrocarbon liquids when in contact with rapidly rising carbon dioxide gas bubbles.

Inert gas dilution of the fuel generated by evaporation at the liquid surface is characteristic of both the methods illustrated in FIGS. 1 and 2. This dilution of the fuel gas generated combats the fire through leaning of the combustible mixture. As the mixture becomes leaner the flame is moved away from the liquid surface in search of oxygen from the ambient air. Moving the flame away from the liquid surface reduces the amount of radiated heat transmitted to the liquid surface for the generation of fuel vapors. Eventually the leaning may reach a point where combustion is no longer supported.

In one embodiment, the thrower system [100] is adapted to throw several thousand (e.g., 5000-6000) pounds of frozen projectiles per hour onto a fire. In that case, the transportable container [1] may have a similar capacity of frozen projectiles [3]. Also, preferably, the thrower system can throw the frozen projectiles over a distance of at least 100 feet, more preferably, several hundred feet.

Although the thrower system [100] is described in detail above for applying cryogenic material to treat a fire, other application devices and methods are possible. For example, frozen projectiles the size of rice kernels may be blown out with a gas onto the fire.

As may now be more fully appreciated, the methods and apparatus of this invention allow a far more effective use of fire extinguishing substances than do the techniques of the prior art. None of the apparatus employed is directly exposed to the fire, as is the case with most fixed or semi-fixed extinguishing systems. In contrast, ordinary techniques of foam application to tank fires subject the foam jet to intense thermal radiation as it passes through the flames and escapes upon the surface of the burning liquid. The use of inert gas, cold frozen carbon dioxide, and bulk liquid agitation by the bubbles enhances the fire fighting atmosphere at and atop the liquid surface.

While the invention has been shown and described with reference to certain preferred embodiments thereof, it will be understood by those skilled in the art that various changes in form and details are possible which remain within the concept and scope of the invention. Such variations would become clear to one of ordinary skill in the art after inspection of the specification, drawings and claims herein. The invention therefore is not to be restricted except within the spirit and scope of the appended claims.

What is claimed is:

1. A method of treating a fire on a liquid surface, comprising:
locating a thrower system a desired distance from the fire;
providing a plurality of cryogenic projectiles to the thrower system; and
projecting the cryogenic projectiles from the thrower system onto the fire.

2. The method of claim 1, wherein the cryogenic projectiles are adapted to float on the liquid surface.

3. The method of claim 2, wherein the floating cryogenic projectiles sublime into an inert gas, cooling the liquid surface and reducing evaporation of the liquid and fuel supply to the fire.

4. The method of claim 2, wherein the floating cryogenic projectiles sublime into an inert gas forming an insulating cover on the liquid surface, reducing heat input from the fire into the liquid and reducing evaporation of the liquid fueling the fire.

5. The method of claim 2, wherein the floating cryogenic projectiles sublime into an inert gas mixing with ambient gases and fuel vapors above the liquid surfaces, reducing an amount of oxygen available for consumption by the fire.

6. The method of claim 1, wherein the cryogenic projectiles comprise CO₂.

7. The method of claim 6, wherein the frozen cryogenic projectiles include an inert solid material in addition to carbon dioxide.

8. The method of claim 6, wherein the frozen cryogenic projectiles include Perlite.

9. The method of claim 1, wherein the frozen cryogenic projectiles are hollow.

10. The method of claim 1, wherein the frozen cryogenic projectiles are adapted to sink beneath the liquid surface.

11. The method of claim 9, wherein the frozen cryogenic projectiles sublime into an inert gas, wherein bubbles of the sublimed gas agitating the liquid and causing colder bulk liquid in the container to rise to the surface

12. The method of claim 1, wherein frozen cryogenic projectiles are solid.

13. The method of claim 1, wherein the desired distance is at least 100 feet.

14. The method of claim 1, wherein projecting the frozen cryogenic projectiles from the thrower system onto the fire comprises projecting the projectiles at a rate of at least 5000 pounds of projectiles per hour.

15. A system for treating a fire, comprising:
a plurality of frozen projectiles; and
means for propelling a stream of the frozen projectiles onto the fire.

16. The system of claim 15, wherein the frozen projectiles comprise carbon dioxide.

17. The system of claim 16, wherein the frozen projectiles further comprise an inert solid material.

18. The system of claim 16, wherein the frozen projectiles further comprise Perlite.

19. The system of claim 15, wherein the frozen projectiles have a spherical or near-spherical shape.

20. The system of claim 15, wherein the frozen projectiles are hollow.

21. The system of claim 15, wherein the frozen projectiles are solid.

22. The system of claim 15, wherein the frozen projectiles have a specific density that is less than unrefined oil.

23. The system of claim 15, wherein the frozen projectiles have a specific density that is less than at least one of gasoline and diesel fuel.

24. The system of claim 15, wherein the means for propelling a stream of the carbon dioxide ice projectiles onto the fire is a thrower system having a rotating throw mechanism.

25. A method of treating a fire, comprising:
providing a plurality of frozen projectiles; and
applying the frozen projectiles onto the fire.

26. The method of claim 25, wherein the frozen projectiles comprise carbon dioxide.

27. The method of claim 26, wherein the frozen carbon dioxide projectiles include an inert solid material in addition to carbon dioxide.

28. The method of claim 26, wherein the frozen projectiles include Perlite.

29. The method of claim 25, wherein the frozen projectiles are hollow.

30. The method of claim 25, wherein the frozen projectiles are solid.

31. The method of claim 25, wherein applying the frozen projectiles onto the fire comprises hurling the frozen projectiles at a rate of at least 5000 pounds of projectiles per hour.
